(19) United States
(12) Patent Application Publication
(10) Pub. No.: US 2004/0000031 A1
(43) Pub. Date: Jan. 1, 2004

(54) Triaxial hinge for display device

(76) Inventor: Chia Ming Hsu, Tainan (TW)

Correspondence Address: MERCHANT & GOULD P.C., P.O. Box 2903, Minneapolis, MN, 55402-0903, US

(21) Appl. No.: 10/401,247

(22) Filed: Mar. 27, 2003

(30) Foreign Application Priority Data
Jun. 28, 2002 (TW) 091210055

(51) Int. Cl. E05D 11/08

(52) U.S. Cl. 16/339; 16/337

(57) ABSTRACT

A triaxial hinge for supporting a flat panel display device on an external member includes a first member, a second member, a third member and a supporting member. The first member is fixed to the external member. The second member is pivotally connected to the first member for defining a first pivot. The third member is pivotally connected to the second member for defining a second pivot perpendicular to the first pivot. The supporting base is pivotally connected to the third member for defining a third pivot perpendicular to the first and second pivots. The flat panel display device is attached to the supporting base and can be pivoted on the first, the second, and the third pivots, respectively, with respect to the first member.

### BACKGROUND OF THE INVENTION

1. Field of the Invention

The present invention generally relates to a triaxial hinge, and more particularly to a triaxial hinge for supporting a flat panel display on a desk or hanging a flat panel display on a wall.

2. Description of the Related Art

Liquid crystal display (“LCD”) has been used widely, and a typical liquid crystal display can be rotated or tilted according to a user's need. For example, U.S. Pat. No. 5,941,493, entitled “LCD Support System” issued to Chen on Aug. 24, 1999 discloses a support structure for supporting an LCD. However, in this support structure, the LCD may just be rotated in one direction within a predetermined angle. Also, Taiwan Patent Publication No. 327460, entitled “Liquid Crystal Display Device Capable Of Being Inclined Forward Or Backward” published on Feb. 21, 1998, discloses an LCD capable of being inclined forward or backward in accordance with the required inclined angle. However, this LCD can be rotated only in one direction and cannot be rotated in other direction, so the need of a user may not be fully satisfied.

Further, Taiwan Patent Publication No. 465656, entitled “Dual-axial Hinge For Liquid Crystal Display” published on Nov. 11, 2001, discloses a dual-axial hinge for a liquid crystal display comprising a lower bracket, a lower bearing, a supporter, a connection bracket, an upper bearing, and an upper bracket. However, the structure of the connection bracket for connecting the lower bearing and the upper bearing is complex and occupies certain space. Also, the hinge has to be provided with the projection and the restriction mechanism to restrict the rotation angle, such that the cost of manufacturing is increased.

Furthermore, U.S. Pat. No. 6,427,288, entitled “Tilting hinge” issued to Saito on Aug. 6, 2002, discloses a tilting hinge for frictionally pivotably vertically, horizontally, and swingably supporting a display device. However, the friction washer of the tilting hinge will be worn out or broken during the repeating rotation of the display device, so the rotation of the display device is not restricted within a desired angle.

Besides, the above-mentioned hinge apparatus of large dimensions occupies large space and thus cannot be widely adapted to various displays. These hinge apparatus can only support the LCD on a desk, but cannot be used to hang the LCD on a vertical wall, thereby limiting the uses of the hinge apparatus.

Accordingly, there exists a need for a multi-direction hinge which is simply structured and compact so as to be adapted to support varied displays.

### SUMMARY OF THE INVENTION

In one aspect, the present invention relates to a triaxial hinge which is simply structured and compact, and is widely adapted to various flat panel displays.

In another aspect, the present invention relates to a triaxial hinge of a display, and the triaxial hinge is provided with restriction elements of rotation angles formed inside the hinge so as to reduce the volume of the hinge.

In yet another aspect, the present invention relates a triaxial hinge for supporting a flat panel display device on an external member. The triaxial hinge includes a first member, a second member, a third member and a supporting member. The first member is fixed to the external member. The second member is pivotally connected to the first member for defining a first pivot. The third member is pivotally connected to the second member for defining a second pivot perpendicular to the first pivot. The supporting base is pivotally connected to the third member for defining a third pivot perpendicular to the first and second pivots. The flat panel display device is attached to the supporting base and can be pivoted on the first, the second, and the third pivots, respectively, with respect to the first member.

Accordingly, the triaxial hinge according to the present invention is simply structured, and the cost and the dimension of the triaxial hinge are reduced for being adapted to various displays.

### BRIEF DESCRIPTION OF THE DRAWINGS

Other objects, advantages, and novel features of the invention will become more apparent from the following detailed description when taken in conjunction with the accompanying drawings.

FIG. 1 is a perspective view of a triaxial hinge of an embodiment according to the present invention for supporting an LCD on a holder frame.

FIG. 2 is an exploded view of the triaxial hinge of an embodiment according to the present invention and a bracket.

FIG. 3 is a perspective view of a first member.

FIG. 4a is a perspective view of a second member.

FIG. 4b is a side view of a second member.

FIG. 5a is a perspective view of a third member.

FIG. 5b is a side view of a third member.

FIG. 6a is a perspective view of a supporting base.

FIG. 6b is a side view of a supporting base.

FIG. 7a is a perspective view of the triaxial hinge at a view angle.

FIG. 7b is a cross sectional view of the triaxial hinge along the line A-A′ in FIG. 7a.

FIG. 8a is a perspective view of the triaxial hinge at another view angle.

FIG. 8b is a cross sectional view of the triaxial hinge along the line B-B′ in FIG. 8a.

FIG. 9 is a perspective view of the triaxial hinge at still another view angle.

FIG. 10 is a perspective view showing a liquid crystal display mounted on a bracket of a vertical wall by the triaxial hinge.

### DESCRIPTION OF THE PREFERRED EMBODIMENT

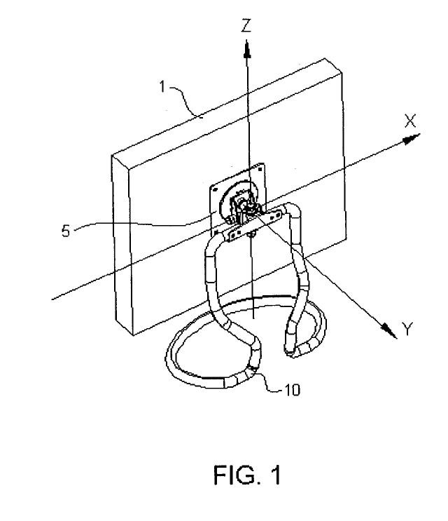

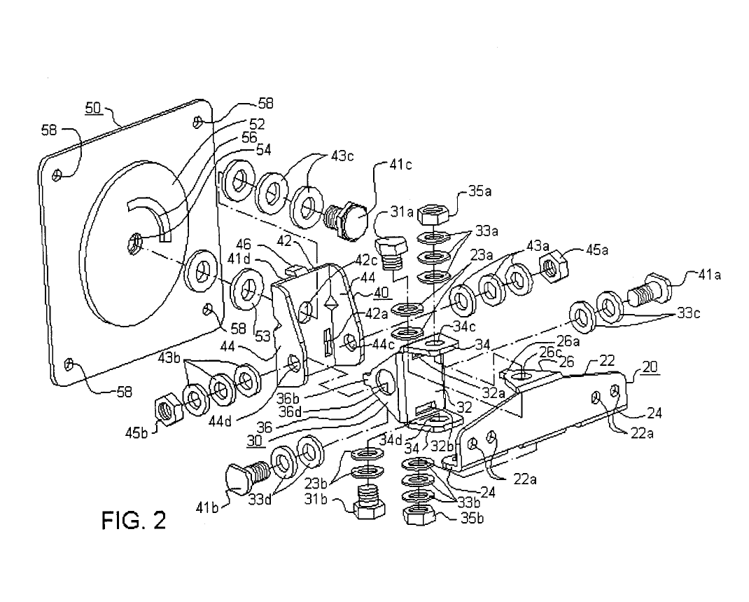

Referring to FIG. 1, a triaxial hinge 5 according to one embodiment of the present invention is shown for mounting a liquid crystal display (hereinafter refer to as “LCD”) 1 on a holder frame 10. Referring to FIG. 2, among other things, the triaxial hinge 5 has a first member 20, a second member 30, a third member 40, and a supporting base 50.

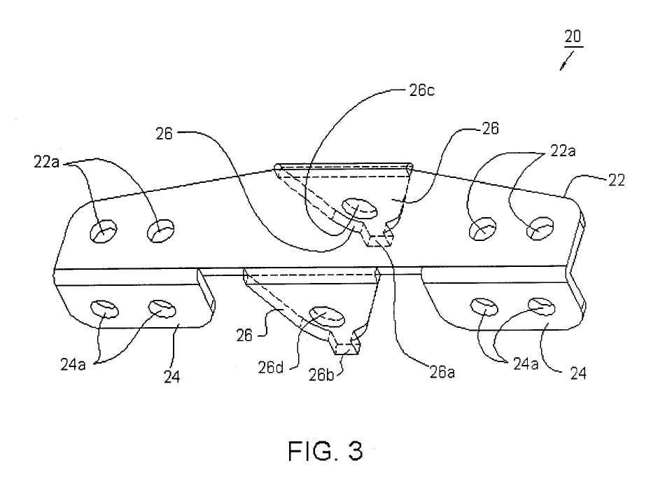

Referring now to FIGS. 2 and 3, the first member 20 includes a first main board 22, two fins 24, and two connection plates 26. The first main board 22 is substantially rectangular in shape and has holes 22a. The fins 24 are substantially perpendicular to the main board 22 and are respectively disposed on the opposite ends of one edge of the first main board 22. The connection plates are substantially triangular in shape and substantially perpendicular to the first main board 22, and are respectively disposed on the central portions of the opposite edges of the first main board 22.

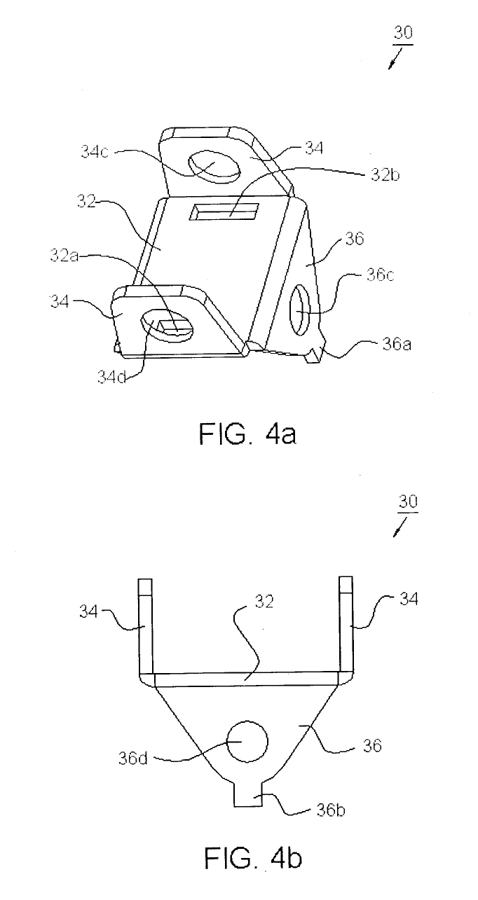

Referring to FIGS. 2 and 4a-4b, the second member 30 according to one embodiment of the present invention is shown. The second member 30 has a second main board 32, two first connection plates 34, and two second connection plates 36. The second main board 32 is substantially rectangular in shape and has two rectangular slots 32a, 32b. The first connection plates 34, which are trapezoid in shape, are respectively disposed on two short edges of the second main board 32 and perpendicular to the second main board 32. The first connection plates 34 further comprise connection holes 34c, 34d. The second connection plates 36, which are trapezoid in shape, are respectively disposed on two long edges of the second main board 32 and perpendicular to the second main board 32. The first connection plates 34 and the second connection plates 36 are extending toward opposite directions. The second connection plates 36 further comprise projections 36a, 36b and connection holes 36c, 36d.

Now referring to FIGS. 2, 3 and 4a-4b, the first member 20 is mounted on the second member 30 by means of the two bolts 31a, 31b which pass through the connection holes 26c, 26d of the first member 20 and the connection holes 34c, 34d of the second member 30, and the two self-locking nuts 35a, 35b. The projection 26a, 26b of the first member 20 are inserted into the slots 32a, 32b of the second member 20. Also, spring washers 23a, 23b and spring washers 33a, 33b are disposed between the bolts 31a, 31b and the first member 20, and between the second member 30 and the self-locking nuts 35a, 35b, respectively.

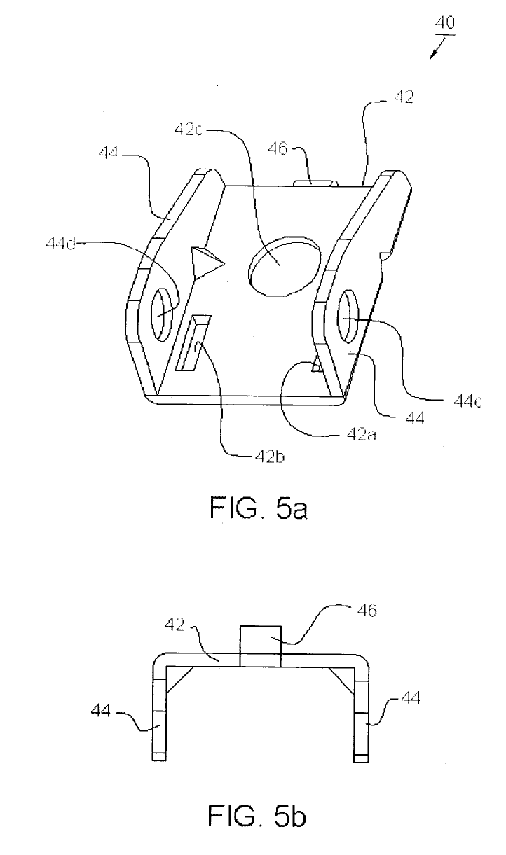

Referring to FIGS. 2 and 5a-5b, the third member 40 according to one embodiment of the present invention is shown. The third member 40 has a third main board 42 and two connection plates 44. The third main board 42 is substantially rectangular in shape and has two rectangular slots 42a, 42b and a connection hole 42c. The connection plates 44, which are trapezoid in shape, are respectively disposed on two long edges of the second main board 32 and perpendicular to the second main board 32. The connection plates 44 further comprise connection holes 44c, 44d. Besides, a projection 46 is formed on the short edge of the third main board 42 and substantially perpendicular to the main board 42. The projection 46 and the connection plates 44 are extending toward opposite directions.

Referring to FIGS. 2, 4a-4b and 5a-5b, the second member 30 is mounted on the third member 40 by means of the two bolts 41a, 41b which pass through the connection holes 36c, 36d of the second member 30 and the connection holes 44c, 44d of the third member 40, and the two self-locking nuts 45a, 45b. The projection 36a, 36b of the second member 30 are inserted into the slots 42a, 42b of the third member 40. Also, spring washers 33a, 33b disposed between the bolts 41a, 41b and the second member 30, and spring washers 43a, 43b are disposed between the third member 40 and the self-locking nuts 45a, 45b.

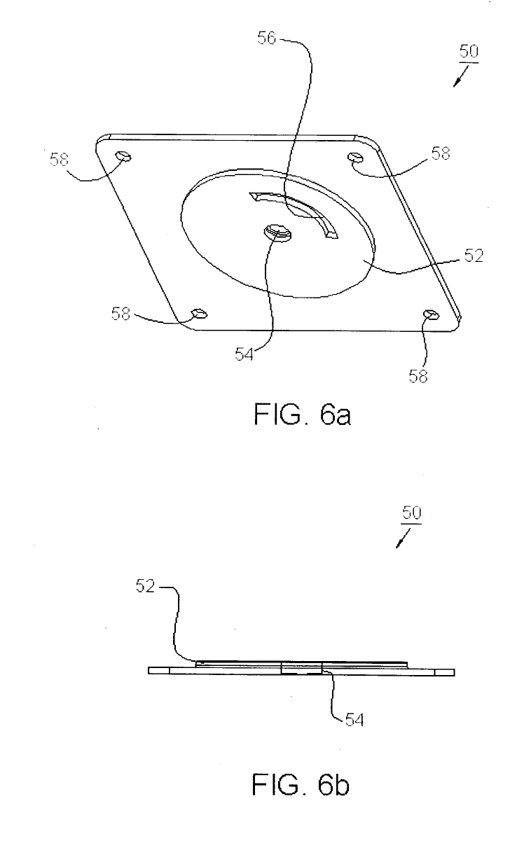

Referring to FIGS. 2 and 6a-6b, the supporting base 50 according to one embodiment of the present invention is shown. The supporting base 50 has a forth main board 52, a central thread recess 54, an arc slot 56, and four hole 58. The arc slot 56 is concentric with the thread recess 54.

The relationship between the supporting base 50 and third member 40 can be further described referring to FIGS. 2, 5a-5b and 6a-6b. The third member 40 is mounted on the supporting base 50 by means of the bolt 41c, which pass through the connection hole 42c of the third member 40 and is screwed into the central thread recess 54. The projection 46 of the third member 40 is inserted into the arc slot 56 of the supporting base 50. Also, spring washers 43c are disposed between the bolt 41c and the third member 40, and spring washers 53 are disposed between the third member 40 and the supporting base 50.

As mentioned above and shown, for example, in FIG. 2, the first member 20 can be pivoted relative to the second member 30 by the bolts 31a, 31b. The second member 30 can be pivoted relative to the third member 40 by the bolts 41a, 41b. The third member 40 can be pivoted relative to the supporting base 50 by the bolt 41c.

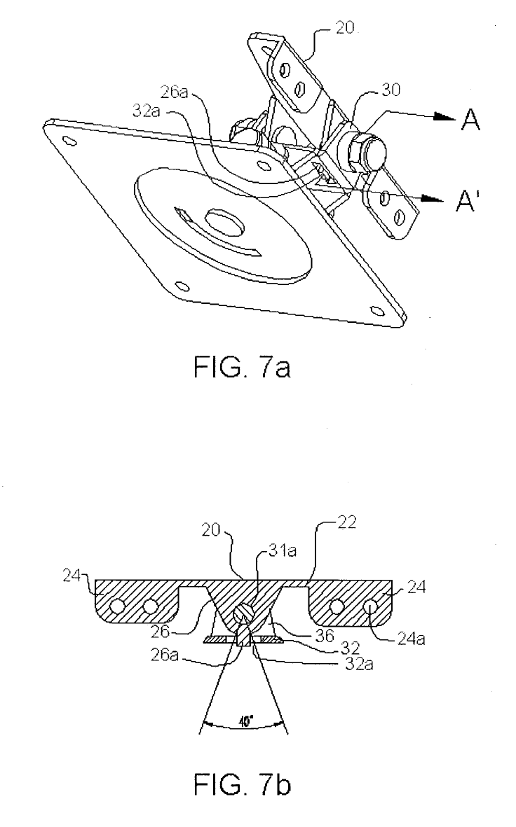

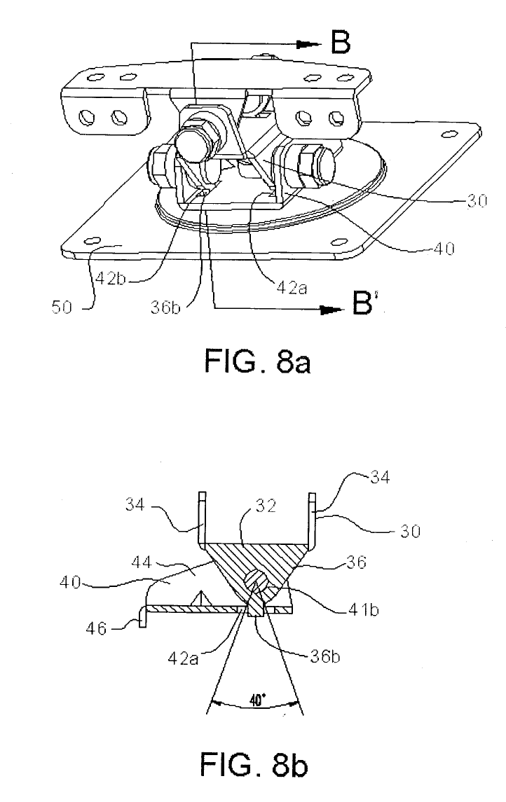

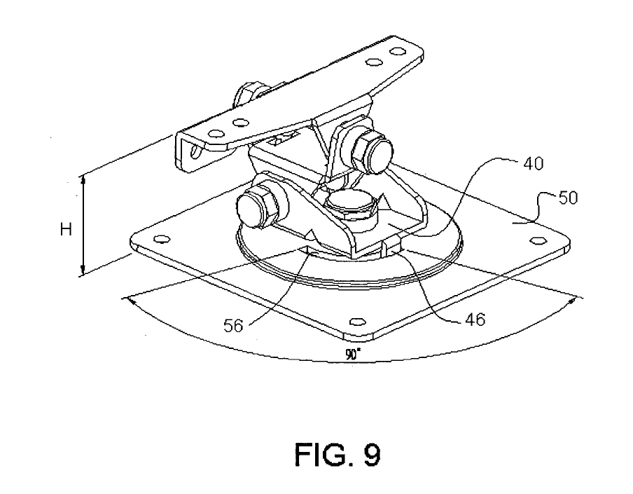

Referring to FIGS. 7a-7b, when the first member 20 is pivoted relative to the second member 30, the two ends of the slots 32a, 32b of the second member 30 interfere with the movement of the projections 26a, 26b such that the pivot or rotation angle is restricted within the range from about +20 degree to about −20 degree, i.e. within about 40 degree. In FIGS. 8a and 8b, when the first member 20 is pivoted relative to the second member 30, the two ends of the slots 42a, 42b of the third member 40 interfere with the movement of the projections 36a, 36b such that the pivot or rotation angle is restricted within the range from about +20 degree to about −20 degree, i.e. within about 40 degree. In FIG. 9, when the third member 40 is pivoted relative to the supporting base 50, the two ends of the arc slot 56 of the supporting base 50 interfere with the projection 46 such that the pivot or rotation angle is restricted within about 90 degree.

Further, as shown in FIGS. 1 and 2, the LCD 1 is mounted on the supporting base 50 by means of the fasteners, such as bolts, rivets, which pass through the holes 58 of the supporting base 50 and the back housing of the LCD 1.

Therefore, as shown in FIG. 1, the LCD 1 is attached to the holder frame 10 by the triaxial hinge 5 according to the present invention, and the LCD 1 is able to be pivoted or rotated upward and downward within 20 degree (on X-axis), leftward and rightward within 20 degree (on Y-axis), and counterclockwise or clockwise within 90 degree (on Z-axis).

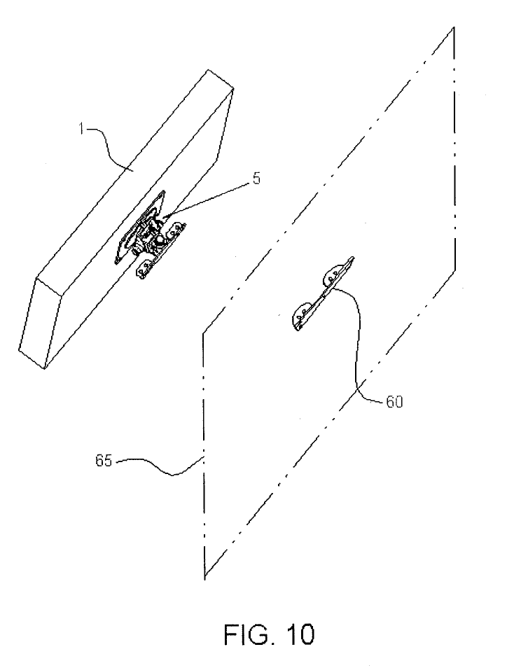

In another arrangement according to the present invention, an LCD is mounted on a vertical wall by the triaxial hinge according to the present invention. As shown in FIG. 10, the LCD 1 is mounted on a bracket 60 of a vertical wall 65 (shown as the phantom line). Alternatively, without the bracket 60, the LCD 1 is directly mounted on the vertical wall 65 by the fasteners which pass through the holes 22a of the first member 20.

Additionally, between the bolts and the corresponding nuts and between the bolt 41c and the corresponding central thread recess 54, a predetermined torque can be applied by a torque wrench. By varying the torque, the friction force between the washers and the bolts and between the washers and the nuts can be varied so as to adjust the force of turning the LCD 1 relative to the triaxial hinge 5. In the embodiment according to the present invention, the torque is preferably 20 kg·m. Further, in the embodiment according to the present invention, there are the two bolts 31a, 31b and the two bolts 41a, 41b disposed between the first member 20 and the second member 30 and between the second member 30 and the third member 40, respectively, so the torque on the bolts can be individually adjusted, if desired.

Further, the above-mentioned force can be adjusted to a suitable value by varying the number of the washers. Also, the first, second, third members 20, 30, 40 of the triaxial hinge 5 according to the present invention are formed by the process of punching the sheet material. Therefore, the limiting elements, i.e. the projections 26a, 26b, the projections 36a, 36b, the projection 46, the slots 32a, 32b, the slots 42a, 42b, and the arc slot 56 are integrally formed with the members of the triaxial hinge 5, so the limiting elements are strong and durable.

In addition, the triaxial hinge 5 is compact in volume. As shown in FIG. 9, the height H of the triaxial hinge 5 is about 42 mm. It will be apparent to those skilled in the art that the triaxial hinge 5 can be adapted to support other type of flat panel display, such as plasma or light-emitting diode display. Besides, the triaxial hinge 5 can be easily covered with a figurative housing element for providing the aesthetic and hidden function.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A triaxial hinge for supporting a flat panel display device on an external member comprising:
a first member for being fixed to the external member;
a second member pivotally connected to the first member and defining a first pivot;
a third member pivotally connected to the second member and defining a second pivot perpendicular to the first pivot; and
a supporting base pivotally connected to the third member and defining a third pivot perpendicular to the first and second pivots,
wherein when the flat panel display device is attached to the supporting base, the flat panel display device is pivotable on the first, the second, and the third pivots, respectively, with respect to the first member.

2. A triaxial hinge according to claim 1, wherein
the first member further comprises two first connection plates;
the second member further comprises two second connection plates, two third connection plates and two first bolts, wherein the two second connection plates are pivotly connected to the two first connection plates of the first member by the first bolts, respectively, and the two first bolts define the first pivot; and
the third member further comprises two forth connection plates and two second bolts, wherein the two forth connection plates are pivotly connected to the two third connection plates of the second member by the second bolts, respectively, and the two second bolts define the second pivot.

3. A triaxial hinge according to claim 2, wherein:
the supporting base further comprises a thread hole and a third bolt, wherein the supporting base is pivotly connected to the third member by the cooperation of the thread hole and the third bolt, and the third bolt defines the third pivot.

4. A triaxial hinge according to claim 3, further comprising a first, a second, and a third torque adjusting means for adjusting the torque turning the first member relative to the second member, the second member relative to the third member, and the third member relative to the supporting base, respectively.

5. A triaxial hinge according to claim 4, wherein the first, the second, the third torque adjusting means are washers.

6. A triaxial hinge according to claim 2, further comprising a first, a second, and a third limiting devices for restricting the rotation angle of the first member relative to the second member, the second member relative to the third member, and the third member relative to the supporting base, respectively.

7. A triaxial hinge according to claim 6, wherein:
the first limiting device comprises a first projection disposed on the first member and a first slot disposed on the second member;
the second limiting device comprises a second projection disposed on the second member and a second slot disposed on the third member; and
the third limiting device comprises a third projection disposed on the third member and a third slot disposed on the supporting base.

8. A triaxial hinge according to claim 1, wherein the external member is a holder frame.

9. A triaxial hinge according to claim 1, wherein the external member is a wall.

10. A triaxial hinge according to claim 1, wherein the external member is a bracket.

11. A triaxial hinge according to claim 1, wherein the flat panel display device is an LCD display.

12. A triaxial hinge according to claim 1, wherein the flat panel display device is a plasma display.

13. A triaxial hinge according to claim 1, wherein the flat panel display device is a light-emitting diode display.
